(19) United States
(12) Patent Application Publication
(10) Pub. No.: US 2025/0246423 A1
(43) Pub. Date: Jul. 31, 2025

(54) APPARATUS AND METHOD FOR GENERATION OF IONS FROM SAMPLE MATERIAL

(71) Applicant: Bruker Daltonics GmbH & Co. KG, Bremen (DE)

(72) Inventor: Andreas HAASE, Bremen (DE)

(21) Appl. No.: 19/037,937

(22) Filed: Jan. 27, 2025

(30) Foreign Application Priority Data
Jan. 25, 2024 (DE) 10 2024 102 098.9

(51) Int. Cl. H01J 49/16

(52) U.S. Cl. CPC H01J 49/164

(57) ABSTRACT

An apparatus for generating ions from sample material deposited on a sample carrier includes a chamber that keeps the sample material in a conditioned environment, an ablation device that locally ablates the deposited sample material and converts it to the gas phase, an energy input device that exposes the ablated sample material to an input energy burst, and an extraction device that extracts ions from the ablated sample material exposed to the input energy burst and transfers them to an ion processing apparatus, the ablation energy burst and/or input energy burst comprising a beam of coherent electromagnetic waves and the ablation device and/or the energy input device comprising a beam distributor that provides a plurality of optically parallel beam paths which each have a frequency multiplier unit and are combined again, wherein all frequency multiplier units emit a uniform output frequency. Likewise disclosed is a corresponding method.

### BACKGROUND OF THE INVENTION

### Field of the Invention

The invention relates to apparatuses and methods by which gas phase ions are generated by ablation of sample material deposited on a sample carrier and conversion to the gas phase, and exposure of the ablated sample material to a high-energy beam that promotes ionization and preferably increases the degree of ionization. The apparatuses and methods may find use in particular in mass analysis using MALDI (Matrix-Assisted Laser Desorption/lonization), and especially in imaging mass spectrometry of sample material having a two-dimensional extent, for example tissue sections.

### Description of the Related Art

The prior art is elucidated hereinafter with reference to one specific aspect. However, this should not be understood to be a restriction. Useful advances and alterations from what is known from the prior art may also be applicable beyond the comparatively narrow scope of this introduction and will be immediately apparent to trained practitioners in this field after reading the present disclosure.

MALDI is an ionization technique which is used in mass analysis or mass spectrometry in order to convert large and sensitive molecules, for example proteins, peptides, oligonucleotides, polysaccharides or synthetic polymers, to gas phase ions that are then sorted and detected by mass or mass-to-charge ratio m/z. MALDI is particularly suitable for the analysis of molecules having a mass of more than 500 atomic mass units, especially owing to the low tendency to fragmentation, and is frequently used in combination with a time-of-flight mass spectrometer (TOF-MS), which offers coverage of a broad mass range and high mass resolution. MALDI mass spectrometry finds use in biochemistry, proteomics, genomics, glycomics, polymer chemistry and forensics.

The basic process in MALDI consists of two steps: sample preparation and laser desorption/ionization (followed by mass analysis). Sample preparation influences the quality and reproducibility of the measurement results. The sample material containing analyte molecules is mixed with a suitable matrix substance, generally a small organic molecule that efficiently absorbs the laser energy in the crystallized state and passes it on to the analyte molecules. A preferred matrix substance protects the analyte molecules from thermal breakdown, promotes ionization thereof, has high absorption at the laser wavelength used (typically in the UV range), is compatible with the analyte molecules, has a small intrinsic mass (in order to keep background low in the mass spectra), and has good crystallization properties (in order to ensure uniform distribution of the analyte molecules through the crystal structure).

The choice of matrix substance is made with regard to the type of analyte molecules. For peptides and proteins, for example, aromatic acids are frequently used, such as sinapic acid, α-cyano-4-hydroxycinnamic acid or 2,5-dihydroxybenzoic acid, whereas diaminobenzophenone or 3-hydroxypicolinic acid are of better suitability for oligonucleotides. Sample material and matrix substance are dissolved in a suitable solvent and mixed in a particular ratio that varies according to the concentration and molecular mass of the analyte molecules (typically 5000-10 000 to 1). The mixture is then applied to a metal plate or some other conductive plate, which serves as sample carrier, and dried under air or under reduced pressure in order to form crystals that embed the analyte molecules into the matrix substance. The sample can be prepared in various ways, for example by the dried droplet method or the thin layer method.

Laser desorption/ionization is the step in which analyte molecules are converted from the crystals of the matrix substance to the gas phase and ionized. For this purpose, a short, intense laser pulse is directed onto the sample material, which desorbs and evaporates the crystallized matrix substance. The duration of such a pulse may, for example, be 2-10 nanoseconds at a fluence of typically 10⁶-10⁸ W/cm². The matrix substance transfers some of its energy and charge to analyte molecules that are released from the crystal structure and converted to the gas phase. Analyte molecules are also ionized here, essentially via proton transfer. Ionization is dependent on the matrix substance, the analyte molecules, the solvent, the salt content thereof and pH and the laser fluence, and is generally gentle, such that there is virtually no occurrence of fragmentation, if any. Most of the analyte molecules are detected as singly charged ions (M+H)⁺, although multiply charged ions (M+nH)ⁿ⁺ may also occur. After generation, the ions have high kinetic energy and high velocity that depends on the laser fluence, the matrix substance, the analyte molecules, the residual gas pressure and the electrical field. Kinetic energy and velocity may, for example, be 10-100 electron volts and 10³-10⁴ m/s respectively. The ions may be collected in a vacuum chamber and fed to a mass analyser. In the case of subsequent analysis using a time-of-flight mass analyser with axial extraction (axial TOF), by contrast, the ions are accelerated directly onto the flight path after ablation and ionization.

What is called MALDI-2 (see Jens Soltwisch et al., Science, 10 Apr. 2015, Vol. 348 Issue 6231, 211 ff.) is a further development of the MALDI technique that enables additional ionization of analyte molecules after laser ablation. This involves exposing the analyte molecules that have been detached from the matrix crystal surface to a second laser pulse above the sample carrier in the gas phase, which causes further ionization. The second laser pulse generally has a higher fluence and a shorter wavelength than the first laser pulse that desorbs the matrix substance, i.e., has higher energy, and may be triggered either virtually coincidently with the first laser pulse or after a time delay (typically 0.5-100 microseconds). The MALDI-2 technique increases the ion yield and the sensitivity of the MALDI technique, especially for molecules having a high mass and/or low ionizability, and can also enable selective ionization of particular molecule classes or of particular species from a molecule class in that suitably adjusted laser fluence and laser wavelength are chosen. A notable patent publication with regard to MALDI post-ionization is WO 2010/085720 A1.

Mass spectrometry imaging (MSI) is a technique that allows analysis of the spatial distribution of biomolecules, for example lipids, peptides, proteins, oligonucleotides, metabolites or medicaments, directly from tissue sections without labelling or destruction thereof. The signal intensity of each biomolecule is illustrated in an image that shows the spatial distribution of the biomolecule in the tissue. Mass spectrometry imaging enables a labelling-free, high-resolution and multiparameter analysis of tissues that can give valuable information about the molecular mechanisms of biological processes, diseases and treatments.

In order to obtain a complete molecular picture in an acceptable time in the context of measurement of an extended tissue section, and to do justice to the above-mentioned adaptation flexibility of the MALDI-2 conditions for dedicated molecular classes or subspecies from one molecular class, laser systems having high repetition rates are required (typically 1-10 kilohertz). In the case of MALDI-2, moreover, an average power in the region of several watts at laser wavelength 266 nanometres is to be expected, with regard to the power of the ablation laser. However, commercial laser systems that are suitable for the market in the context of an industrial product, in particular solid-state laser systems, are designed for operation at not more than 600 milliwatts (for example those from Ekspla) and therefore meet these requirements only inadequately, if at all.

A challenge in particular is that the laser light frequently has to be generated at first with quite low photon energy in the infrared spectral region, e.g., 1064 nanometres, and then frequency-multiplied using nonlinear crystals, e.g., beta-barium borate (BBO) crystals, in multiple stages if necessary, to the required useful photon energy, for example to 355 nanometres (frequency tripling) or 266 nanometres (frequency quadrupling). The energy intensity that results from incidence at a high repetition rate at high average laser fluence can lead to a nonuniform and, moreover, temporally variable temperature profile transversely in the crystal and along the axis thereof, which in turn affects the multiplication efficiency thereof. What is responsible for this is in particular a lack of concurrence of the temperature-dependent refractive indices of the crystal for the fundamental oscillation and the second harmonic, where the latter can be generated in an intermediate step both in the case of frequency tripling and quadrupling. This may firstly lead to significant changes over time in the output power of the laser, which constitutes a challenge for stable operation of the laser system over long periods. Secondly, multiplication efficiency can be lowered.

There follows a brief acknowledgement of prior art documents that may be helpful for understanding of the present disclosure:

Patent specification U.S. Pat. No. 4,988,879 discloses methods and apparatuses for volatilization and subsequent ionization of quantifiable femtomolar and smaller amounts of molecules of nonvolatile solid organic materials. A laser pulse is used to desorb organic material from a carrier on which it has been physisorbed. The carrier and laser are matched to one another so as to achieve a heating rate of the carrier surface of at least 10⁶ K/s, where the carrier withstands this heating rate without volatilization. Glass and similar inorganic oxidic substrates are preferred. The molecules thus generated may be ionized, preferably by resonance-amplified multiphoton ionization. The ions thus formed are notable for strong dominance by ions that correspond to the molecules, such that the sensitive and unambiguous resolution thereof by mass spectrometry is possible.

The paper by Y. L. Shao et al. “Two-colour strong-field ionization and dissociation of H₂ using 780 and 390 nm femtosecond pulses” (Journal of Modern Optics, 43:5, 1996, 1063-1070) reports observation of a considerable increase in H₂⁺ and H⁺ ion production when the two-colour pulses of 780 and 390 nanometres are superposed. What is observed is a strong dependence of ion yield on the relative directions of polarization of the two fields. The experimental results are discussed and compared with existing theoretical calculations.

Patent publication DE 101 12 386 A1 (corresponding to U.S. 2002/0155483 A1) discloses generating a fixed pattern of focal points in a time-of-flight mass spectrometer by virtue of particular beam optics for the pulsed laser beam, introducing a pattern of samples on a sample carrier in each case into the pattern of focal points, and imaging the ions of all samples in the laser focal points of the focus pattern by means of an ion-optical imaging system in one or more ion detectors such that the samples in the focal pattern can be measured simultaneously or quasi-simultaneously. The pattern of focal points that occur in a pulsed manner can be generated simultaneously via spatial beam division, or at a fixed location but in a time sequence of the focal points that occur in a pulsed manner via successive deflection.

Patent publication DE 10 2016 124 889 A1 (corresponding to U.S. 2018/0174815 A1) relates to a mass spectrometer having optically pumped lasers, the laser light from which can be used for ionization by laser desorption, for fragmentation of ions by photodissociation (PD), for excitation of ion reactions and for other purposes. What is described for a mass spectrometer is a laser system with which at least two laser beams of different wavelength can be generated in each case for use at different sites along an ion path from an ion source to an ion detector in the mass spectrometer.

Patent publication WO 2020/210688 A1 relates to systems and methods for sample analysis comprising the application of a first beam to a sample using a first laser source, in order to desorb organic material from a site on the sample, and ionization of the desorbed organic material using a second laser source in order to generate ionized organic material. The ionized organic material is then analysed with a mass spectrometer. A second beam of the first laser is then directed onto the sample in order to ablate inorganic material at the site on the sample. The ablated inorganic material is then ionized with the second laser source to generate ionized inorganic material. The mass spectrometer is then used for analysis of the ionized inorganic material. During the analysis, it is also possible to take one or more images of the sample and associate them with the analysis data collected.

Patent specification DE 10 2021 105 327 B3 (corresponding to U.S. 2022/0285142 A1) relates to an apparatus to generate ions from sample material deposited on a substrate that is at least partially transparent to electromagnetic waves, comprising: a support device which has a holder for the substrate, a desorption/ionization unit comprising a desorption device and an ionization device, the desorption device being arranged and designed to desorb deposited sample material from a desorption site on the substrate using at least one energy burst, and the ionization device being arranged and designed to irradiate the desorbed sample material above the substrate after the at least one energy burst using electromagnetic waves, wherein the electromagnetic waves pass through the substrate, before encountering the desorbed sample material, at a location which corresponds to the desorption site, and an extraction device which is arranged and designed to extract ions from the desorbed sample material and transfer them into an analyser.

Patent application publication DE 10 2023 104 393 A1 (corresponding to U.S. 2024/0288439 A1) discloses apparatuses and methods for spectrometry analysis of sample material present in an ablation region on a sample carrier, having the mode of operation comprising: (i) locating the ablation area on the sample carrier and determining a dimension for the ablation area between opposing boundaries of the ablation area; (ii) beam-assisted sampling from the ablation area, for example using MALDI, and mass analysing, for example using an IMS-QoTOF analyser, the ablated and/or desorbed and ionized sample material, wherein a beam impingement surface, which is chosen to be no larger than the dimension for the ablation area, is moved within the boundaries of the ablation area while performing ablation and/or desorption operations and the extension of the beam impingement surface is changed at least once; and (iii) combining the molecular information obtained from the ablation area by means of the ablation and/or desorption operations into a single spectral dataset.

In view of the above details, there is therefore a need to alter and/or adapt the construction and operation of systems that produce energy bursts, and in particular laser systems, such that the above-mentioned difficulties are cleared up or at least alleviated. Further objects to be achieved by the invention will be apparent to the person skilled in the art directly on reading the disclosure that follows.

### SUMMARY OF THE INVENTION

In a first aspect, the present disclosure relates to an apparatus for generating ions from sample material deposited on a sample carrier, having: a chamber arranged and designed to keep the sample carrier and the sample material in a conditioned environment, an ablation device arranged and designed to locally ablate the deposited sample material using an ablation energy burst in the chamber and to convert it to the gas phase, an energy input device arranged and designed to expose the ablated sample material present above the sample carrier in the chamber after the ablation energy burst to an input energy burst, and an extraction device arranged and designed to extract ions from the ablated sample material that has been exposed to the input energy burst and feed them to an ion processing apparatus, where the ablation energy burst and/or input energy burst comprises a beam of coherent electromagnetic waves and the ablation device and/or the energy input device comprises a beam distributor arranged and designed to provide a multitude of optically parallel beam paths which each have a frequency multiplier unit and are combined again for the ablation energy burst and/or input energy burst, where all frequency multiplier units are arranged and designed to emit a uniform output frequency.

The sample material may comprise point preparations, a multitude of which may have been applied in regular arrangement on the sample carrier, or which may extend over an area, for example in the form of a tissue section. Local ablation of sample material from a tissue section or another sample material having a two-dimensional extent can be effected pixel by pixel or image element by image element, i.e., area element by area element, each of which is much smaller than the extended sample material as a whole. In one example, the sample material may also have individual cells that have either been applied to the sample carrier or grown in situ thereon.

The sample material on the sample carrier may have been prepared with a matrix substance for matrix-assisted ionization, e.g., MALDI, optionally supplemented by MALDI-2. Suitable examples are: sinapic acid, which is suitable for proteins and peptides (possible wavelengths: 266, 337 or 355 nanometres); 2,5-dihydroxybenzoic acid (DHB), which is suitable for proteins, peptides and lipids (266, 337 or 355 nanometres); α-cyano-4-hydroxycinnamic acid, which is suitable for peptides (337 or 355 nanometres); 2,4,6-trihydroxyacetophenone, which is suitable for proteins, peptides and oligosaccharides (337 nanometres); 1,5-diaminonaphthalene (DAN), which is suitable for lipids (337 nanometres); 9-aminoacridine (9-AA), which is suitable for nucleic acids (337 nanometres); 2-mercaptobenzothiazole (2-MBT), which is suitable for metabolites (337 nanometres).

The sample carrier may have a plate of stainless steel or an otherwise electrically conductive plate. For MALDI applications in transmitted light or transmission MALDI, the sample carrier may be transparent to electromagnetic waves, for example in the form of indium tin oxide-coated object carrier (indium tin oxide, ITO). The sample carrier may have the dimensions of a standard microtitre plate: length 127.76 millimetres, width 85.48 millimetres, height 14.35 millimetres. The sample carrier may have marked sites with different propensity to wetting, e.g., 96 lyophilic areas in an 8×12 pattern in a lyophobic environment, or alternatively 24, 48, 384 or 1536 lyophilic areas.

The multitude of optically parallel beam paths may be chosen from the group comprising or consisting of: 2, 3, 4, 5, 6, 7, 8, 9, 10, or any other natural number. Particular preference is given to 2, 3 or 4 optically parallel beam paths, since this number is a good balance between advantageous distribution of the energy load according to the teaching disclosed and the complexity of the technical setup.

In various embodiments, the chamber may be in a substantially gas-tight arrangement and design and may be connected to a vacuum source. The vacuum source may take the form of a pump that continuously pumps gas out of the chamber in order to maintain a technical vacuum therein. For example, turbomolecular pumps and cryopumps are usable. Possible pressure levels are in the range of 0.1-100 millibar, preferably 1-10 millibar. But it is entirely possible to generate ions at (or at least close to) atmospheric pressure, about 1000 millibar.

In various embodiments, the chamber may be connected to a gas supply arranged and designed to establish a predetermined gas composition. A conditioned environment may comprise a gas of particular composition. The composition may, for example, substantially consist exclusively of an unreactive inert gas, e.g., molecular nitrogen or helium. A pump can, for example, draw gas out of the chamber, in which case new gas can be replenished in a controlled manner using the gas supply. The mass balance of gas supply and removal by pumps determines the pressure level in the chamber. The gas composition in the chamber may include a dopant gas in order to increase ionization efficiency, as described in the applicant's patent publication DE 10 2020 120 394 A1 (corresponding to U.S. 2022/0037142 A1).

In various embodiments, the ablation device may comprise an ablation pulse laser or pulsed ablation laser, especially a solid-state laser, including beam-guiding ablation optics assemblies that are arranged and designed to direct ablation energy bursts in the form of ablation laser light pulses in reflection mode or in transmission mode locally onto the deposited sample material in the chamber. A pulse rate of the ablation pulse laser or pulsed ablation laser may be selected from the group comprising or consisting of: 1 hertz, 10 hertz, 100 hertz, 1000 hertz, 10 000 hertz, or any other suitable pulse rate value, especially between 1 and 10 000 hertz. An arrangement in which laser light pulses in transmitted light (in transmission) are sent through the sample carrier onto the sample material has the advantage that the optics assemblies required for pulse guiding are arranged beyond the ion generation space and the extraction device present therein and therefore do not interfere with the ion handling. Advantages of the action of ablation energy bursts in reflected light (in reflection) on the sample material are higher sensitivity since the energy burst is focused directly onto the sample material and is not absorbed or scattered by the sample carrier, better reproducibility since the effect of the energy burst is independent of thickness and transparency of the sample carrier, and greater flexibility since different sample carrier materials can be used, for example metal, glass, silicon or plastic, which need not be transparent.

In various embodiments, the beam distributor may comprise a diffractive optical element, DOE, especially a linear beam divider, or a refractive optical element, especially a microlens array. Division of the beam of coherent electromagnetic waves into multiple part-beams, all of which pass substantially simultaneously through essentially superimposed multiplier ranges, allows a reduction in the energy input per frequency multiplier unit and associated unwanted thermal effects in the frequency multiplier units. The beam paths of the part-beams are subsequently combined again before the beam of coherent electromagnetic waves arrives at the intended site of exposure of the ablated sample material above the sample carrier, or are combined again exactly at the intended site of this exposure in the chamber (substantially simultaneously).

In various embodiments, the energy input device may include a laser light generator for generation of input energy bursts, upstream of the beam distributor. The laser light generator preferably comprises an energy input pulse laser or pulsed energy input laser, especially a solid-state laser, and the energy input device preferably includes beam-guiding input optics assemblies that are arranged and designed to direct input energy bursts in the form of energy input laser light pulses that spread substantially parallel or substantially at right angles to a surface normal of the sample carrier into the ablated sample material present above the sample carrier in the chamber. A pulse rate of the energy input pulse laser or pulsed energy input laser preferably corresponds to the pulse rate of an ablation pulse laser or pulsed ablation laser. In particular, an energy input pulse may be triggered with a small time delay relative to an ablation pulse, for example chosen from a group comprising or consisting of: 0.5 microsecond, 1 microsecond, 10 microseconds, 100 microseconds, or any other suitable time difference between ablation energy burst and input energy burst, especially between 0.5-100 microseconds.

In various embodiments, the beam-guiding input optics assemblies may include one or more imaging optics assemblies disposed between a frequency multiplier unit and (i) an exposure site above the sample carrier in the chamber and/or (ii) the laser light generator. Imaging lenses or lens systems may be disposed between a frequency multiplier unit and the exposure site in the chamber, for example a linear microlens array arranged and designed to enable focusing of the beam of coherent electromagnetic waves to the exposure site. It is likewise possible for imaging lenses or lens systems to be disposed between the laser light generator and a frequency multiplier unit, which ensure low-loss and stable beam guiding from the laser light generator to the beam distributor and thence to a frequency multiplier unit.

In various embodiments, the energy input device may be arranged and designed to trigger an energy input laser light pulse after, and timed with, an ablation energy burst. There is preferably a guiding and/or control system that communicates with the ablation device, the energy input device and the extraction device, and is arranged and designed to guide and coordinate the operation of these assemblies. Particular operating parameters that may be employed and monitored by the guiding and/or control system are the beam timing, the beam power, the time intervals between ablation of the sample material from the sample carrier using an ablation energy burst and energy input into the ablated sample material above the sample carrier using an input energy burst, and extraction of ions after the ablation and input energy bursts by actuation of the extraction device.

In various embodiments, the laser light generator may be arranged and designed to generate laser light in the infrared spectral region. Laser media that generate infrared light are preferably used over those that directly generate ultraviolet light, since the former are less prone to environmental influences such as temperature, moisture or dust. The required power can be generated by frequency multiplication using well known optics assemblies that are commercially available inexpensively in various designs.

In various embodiments, the energy input device may include a first generator of a second harmonic, upstream of the beam distributor. Preferably, each frequency multiplier unit may be arranged and designed as a second generator of a second harmonic, and the first generator of a second harmonic and the second generators of a second harmonic together may preferably constitute generators of a fourth harmonic. By virtue of the interplay of a multitude of frequency multiplier units arranged successively in the beam path, the optics setup may have a flexible configuration. It is thus possible to connect a first multiplier unit in series with a further multiplier unit or else a multitude of multiplier units in order to achieve multiplications to different degrees, for example tripling, quadrupling or else quintupling.

In various embodiments, each frequency multiplier unit and/or a generator of a second harmonic may have a multiplier crystal, especially a nonlinear optical crystal such as a beta-barium borate (BBO) crystal. Alternatives to BBO crystals that can be chosen for implementation of the disclosed technical teaching are: lithium triborate (LBO) crystals, potassium titanylphosphate (KTP) crystals, potassium dihydrogenphosphate (KDP) crystals. Nonlinear crystals have high optical quality, a high damage threshold and broad transparency in the UV range. They are therefore suitable for applications that require high exploitation of infrared light and high efficiency of UV generation. They are also quite easy to handle and can be efficiently integrated into an optics setup since they do not require any additional optics assemblies or external stimuli to induce frequency multiplication. In addition, they may also be produced in various shapes and sizes and be matched to the specific demands of a laser system.

In various embodiments, each frequency multiplier unit may be arranged and designed to multiply a single input frequency to a uniform output frequency. In this way, it is possible to simplify the optics setup by an arrangement of a uniform beam path with predetermined optics assemblies upstream of the beam distributor and equipping of all optically parallel beam paths with optics assemblies downstream of the beam distributor such that they all ensure substantially to completely uniform beam conditioning and/or beam guiding, such that—irrespective of the beam path followed by a (part-)beam—a uniformly conditioned beam of coherent electromagnetic waves arrives at the exposure site above the sample carrier. The time taken to traverse the optically parallel beam paths may be substantially uniform. Variances in the traverse time, for example in the nanosecond range, are possible and actually desirable, for example in the picosecond range, especially in the case of true beam division, in which a beam is divided simultaneously between a multitude of optically parallel beam paths and the respective part-beams are placed one on top of another again after passing through the parallel frequency multiplier units, in order to avoid destructive interference effects, for example over relatively long distances covered by the beam recombined from the various part-beams.

In various embodiments, the energy input device may have been arranged and designed to spatially place the multitude of optically parallel beam paths one on top of another in the ablated sample material present above the sample carrier in the chamber, especially in such a way that the beam foci from the various, optically parallel beam paths come to lie one on top of another. Beamforming with the beam focus in the ablated sample material above the sample carrier in the chamber affords the highest energy density of the beam at a site where the interaction between input energy and the ablated sample material is to take place, and is suitable for promoting the formation of additional charge carriers that can ensure an elevated ionization yield.

In various embodiments, the beam distributor may comprise one or more switchable beam switches, especially polarization rotator/s, that is or are arranged and designed to guide an incoming beam of coherent electromagnetic waves substantially completely onto a selected beam path of the multitude of optically parallel beam paths. In this execution, it is possible to achieve a reduction in the load on and an extension of the lifetime of the frequency multiplier units by creating decay phases by alternate addressing during operation, which reduce the energy input into each frequency multiplier unit on average over time. The decay phases may serve to prevent undesirably elevated generation of heat and to remove or to dissipate excess heat from the frequency multiplier units.

In various embodiments, the energy input device may have been arranged and designed to lay the multitude of optically parallel beam paths one on top of another upstream of an exposure site above the sample carrier in the chamber and to focus the correspondingly recombined beam of coherent electromagnetic waves into the exposure site. This design permits reduction to a minimum of the number of beam-guiding input optics assemblies disposed close to the exposure site in the chamber, where they have to share possibly scarce build space with ion-conducting assemblies such as those of the extraction device.

In various embodiments, the extraction device may have one or more electrodes that is or are connected to a voltage source that is arranged and designed to apply a sustained electrical extraction potential or, optionally several times in succession, an electrical extraction potential pulse, the latter preferably timed with an ablation energy burst and input energy burst. The use of extraction potential pulses permits determination of defined time points, with the aid of which the running of an experiment can be ordered and planned, especially with regard to the cycle rate of an analyser, for example the output pulse frequency of an orthogonal time-of-flight analyser (OTOF). A sustainedly applied electrical extraction potential in turn ensures that ions are removed from the generation space shortly after they have been generated, and can help in preventing negative space charge effects that can arise in the case of a high ion generation rate and a resulting considerable accumulation of ions in a limited space.

In various embodiments, the extraction device may include an interface in the chamber to an ion processing chamber in which the ion processing apparatus is disposed. The ion processing chamber is preferably kept at a pressure substantially corresponding to or lower, especially substantially lower, than the pressure in the (ion generation) chamber. In particular, the pressure in the ion processing chamber may be 100 millibar or less. The pressure level in the ion processing chamber is preferably selected from the group comprising or consisting of: 100 millibar or lower, 10 millibar or lower, 1 millibar or lower, 10⁻¹ millibar or lower, 10⁻² millibar or lower, 10⁻³ millibar or lower, 10⁻⁴ millibar or lower, 10⁻⁵ millibar or lower, 10⁻⁶ millibar or lower, 10⁻⁷ millibar or lower, or any other suitable pressure level below 100 millibar, preferably below 10 millibar. More preferably, the chamber and the ion processing chamber are connected gas-tight to one another via the interface, i.e., substantially avoiding uncontrolled leakage of gas.

In various embodiments, the ion processing apparatus may be arranged and designed as an ion analyser, especially as a mobility analyser, mass analyser or combined mobility-mass analyser.

A mass analyser separates charged molecules or molecular ions according to their mass-to-charge ratio, typically referred to as m/z. It is possible to use time-of-flight analysers, for which it is possible to provide either linear or reflector setups and/or those having axial or orthogonal acceleration onto the time-of-flight path. Other types of mass-dispersing analysers can also be used, e.g. quadrupole mass filters (single quads), triple quadruple analysers (“triple quads”), ion cyclotron resonance cells (ICR), Kingdon-type analysers such as the Orbitrap® (Thermo Fisher Scientific) and the like.

An ion mobility separator separates charged molecules or molecular ions according to their collision cross section-to-charge ratio, occasionally referred to as Q/z or σ/z. The basis for this is the interaction of the ion species with an electrical field that couples to the charge of the ions, under the simultaneous action of a buffer gas that acts on the average cross-sectional area of the ion. In particular, drift tube mobility analysers with a static electrical field gradient are known, which drive ions through an essentially stationary gas, resulting in the drift speed of an ion species from the driving force of the electrical field and the slowing force of the impacts with the gas particles. Likewise familiar are trapping ion mobility separators (TIMS) with a constant laminar gas flow that drives the ions onward, counteracted by an electrical field gradient which is varied stepwise with a correspondingly variable slowing force. Travelling wave mobility analysers may also be mentioned. It will be apparent that analysers and separators of the aforementioned types may be coupled in order to be able to separate ion species multidimensionally, i.e., according to more than one physicochemical property such as m/z and Ω/z or o/z.

In a second aspect, the present disclosure relates to a method of generating ions from sample material deposited on a sample carrier, using an apparatus as described above, comprising: locally ablating the deposited sample material using an ablation energy burst and converting it to the gas phase, exposing the ablated sample material present above the sample carrier after the ablation energy burst to an input energy burst, and extracting ions from the ablated sample material that has been exposed to the input energy burst and transferring them to an ion processing apparatus, especially a gas phase analyser.

Embodiments and elucidations that have been described and elucidated in connection with the apparatus according to the first aspect of the present disclosure are likewise applicable to the method according to the second aspect of the present disclosure.

### BRIEF DESCRIPTION OF THE DRAWINGS

For a better understanding of the invention, reference is made to the figures that follow. The elements in the figures are not necessarily shown true to scale, but are intended primarily to illustrate the principles of the disclosure (schematically for the most part). In the figures, mutually corresponding elements in the different views are identified by the same reference numerals.

FIG. 1A shows a schematic of an ion generation apparatus with a triggered ablation beam in reflected light or in reflection, which is suitable for a configuration according to principles of the present disclosure.

FIG. 1B shows a schematic of the ion generation apparatus from FIG. 1A with an ablation cloud of the sample material shortly after incidence of the ablation beam in reflected light or in reflection.

FIG. 1C shows a schematic of the ion generation apparatus from FIG. 1A with a triggered energy input beam directed into the ablation cloud.

FIG. 2 is a schematic illustration of a first embodiment of the new beam guiding according to principles of the present disclosure (spatial distribution of the beam energy).

FIG. 3 is a schematic illustration of a further embodiment of the new beam guiding according to principles of the present disclosure (temporal distribution of the beam energy).

FIG. 4A is a schematic illustration of an embodiment of an ion generation apparatus that works with coherent electromagnetic waves in transmission light or in transmission, with a triggered ablation beam.

FIG. 4B shows a schematic of the ion generation apparatus from FIG. 4A with an ablation cloud of the sample material shortly after incidence of the ablation beam in transmitted light or in transmission.

FIG. 4C shows a schematic of the ion generation apparatus from FIG. 4A with a triggered energy input beam directed into the ablation cloud.

### DETAILED DESCRIPTION

While the invention has been described and elucidated using a number of embodiments, experts in the field will recognize that various alterations can be undertaken in form and detail without departing from the scope of the technical teaching defined in the appended claims.

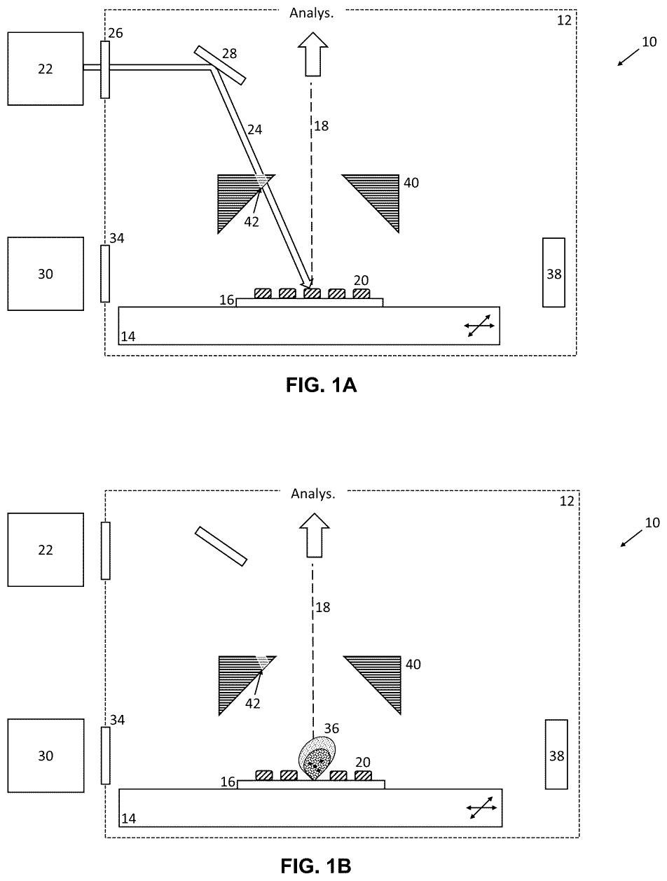

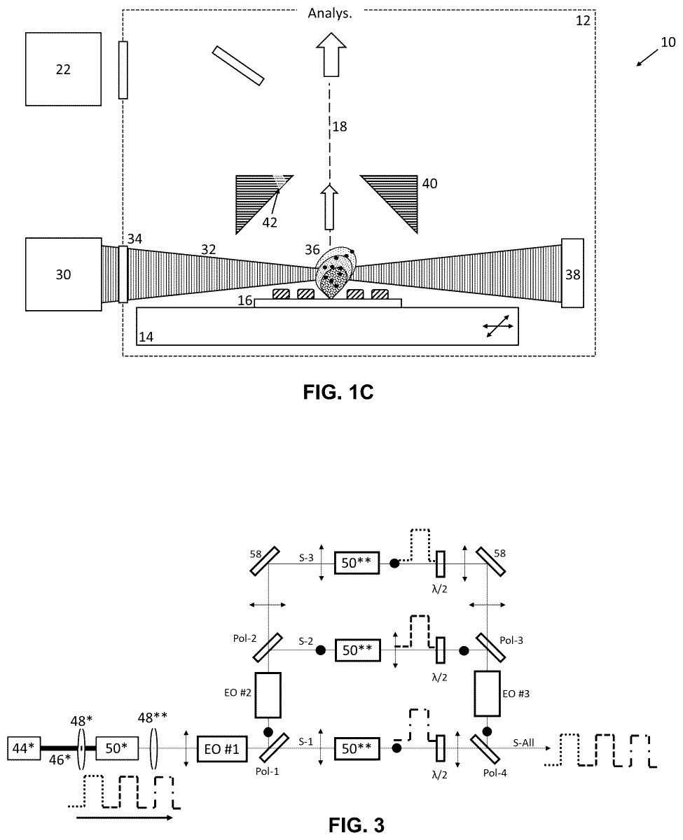

FIG. 1A shows a schematic of an ion generation apparatus 10 in which principles of the present disclosure can be implemented. A chamber 12 which may be in gas-tight form and may be connected to a pump (not shown) in order to be kept at a predetermined reduced pressure contains a control element 14 to which a sample carrier 16 can be applied and which is capable of moving the sample carrier 16 in at least two spatial directions that typically extend parallel to the surface of the sample carrier 16 (at right angles to and along the horizontal of the imaging plane). Movement along the third spatial direction, which is typically parallel to a surface normal 18 of the sample carrier 16, may but need not be implementable. The sample carrier 16 may bear sample material 20 on its surface, which, in the schematic example shown, has a field of individual and isolated point preparations. It is equally possible, of course, that the sample material 20 extends over an area and covers a significant portion of the sample carrier surface and can be locally sampled in a coherent body, for example a tissue section.

FIG. 1A shows a schematic of an ablation device 22 which, in the present context, may take the form of a device with which a pulsed beam of coherent electromagnetic waves 24 is coupled from the outside through a window 26 into the chamber 12 and directed via a deflecting mirror 28 locally onto the sample material 20. The irradiated point preparation may have been prepared, for example, with a MALDI matrix substance that absorbs and distributes the energy of the pulse beam 24, which removes matrix substance and sample material 20 and converts them to the gas phase; see FIG. 1B.

Likewise indicated in FIG. 1A is an energy input device in the form of a pulse laser 30, the pulses 32 from which are coupled from outside through a window 34 into the chamber 12 and directed substantially at right angles to the surface normal 18 of the sample carrier 16 above the sample carrier 16 into an ablation cloud 36 of the sample material 20, in order to interact with the ablated sample material therein; see FIG. 1C. After passing through the ablation cloud 36, the unutilized energy is absorbed in a beam trap 38 and neutralized. There are possible embodiments, encompassed by the present disclosure, in which a multiple reflection cell guides the unutilized portions of the pulse 32 repeatedly through the ablation cloud 36; see, for example, FIG. 17 of WO 2010/085720 A1, which is hereby incorporated by reference.

Also indicated in FIG. 1A is an extraction device in the form of a funnel-shaped electrode arrangement 40 to which a permanent electrical extraction potential may be applied in order to extract ions from the ion generation space immediately after they have been generated and to feed them to a connected analyser that may be disposed in an adjoining reduced-pressure chamber (not shown), or to which electrical extraction potential pulses are applied, timed with a cycle of the ablation and input energy bursts (here in the form of laser pulses 24 and 32). The funnel shape serves in particular to densify ions upon exit from the ion generation space in order to be able to pass on an ion beam or an ion packet without loss to a connected ion processing apparatus (not shown). The funnel-shaped electrode arrangement 40 may have a cutout 42 in order to enable passage of the pulsed beam 24 for incidence onto the sample material 20 and onto the sample carrier 16 in reflected light or in reflection.

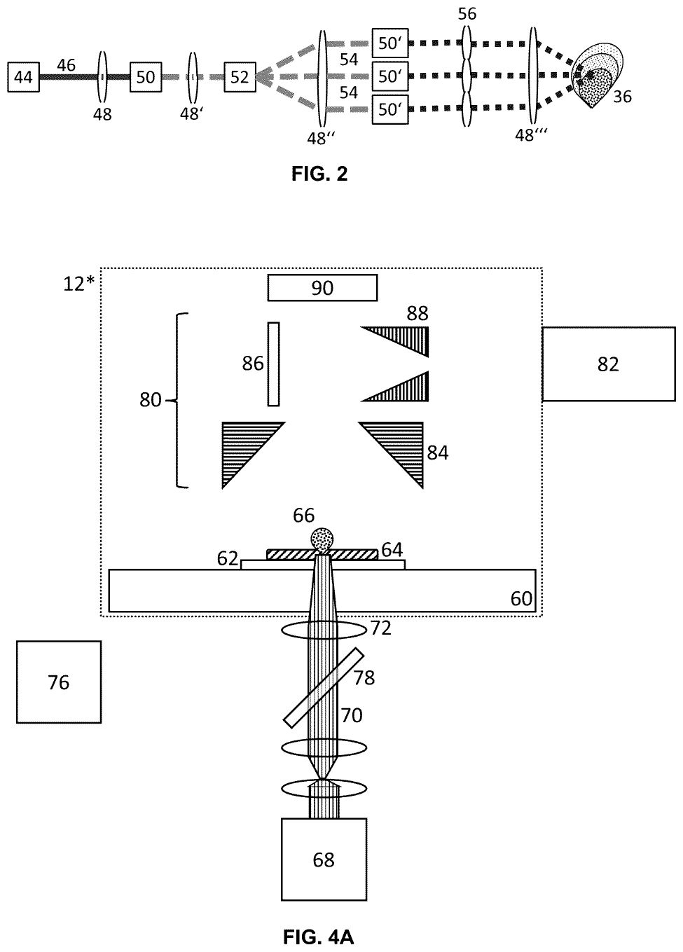

FIG. 2 shows a schematic of a beam profile from the site of generation of the beam (on the left in the figure) up to the site where the beam is applied (on the right in the figure), according to principles of the present disclosure.

A laser light generator 44 emits pulses 46 of coherent electromagnetic waves in the infrared spectral region that are conditioned by an imaging lens system 48 for entry into a first generator of a second harmonic 50, which may take the form of a nonlinear crystal, for example of an LBO crystal. Given an output wavelength of 1064 nanometres, frequency doubling leads to a pulse wavelength of 532 nanometres. After passing through a further imaging lens system 48′ for collimation, the pulses 46 enter a diffractive optical element 52 that may take the form of a linear beam divider, for example. The beam divider branches the incoming output beam in the present case into three identical part-beams that follow optically parallel beam paths 54. Branching into three beam paths 54 is illustrative and may be changed to a different multitude of beam paths if it seems beneficial to the application. The energy of the pulsed beam 46 may be divided in equal parts between the different, optically parallel beam paths 54. The optically parallel beam paths may be configured such that there are substantially no or only small differences in traverse time for the different part-beams. A further imaging lens system 48″, in the focal plane of which the diffractive optical element 52 lies, focuses the part-beams on the optical parallel beam paths 54 and guides them to second generators of a second harmonic 50′, which may likewise take the form of nonlinear crystals. In the case of an entry wavelength of 532 nanometres, the second frequency doubling leads to a pulse wavelength of 266 nanometres, which is particularly suitable for an input energy burst into an ablation cloud 36 of ablated sample material. Based on the pulses 46 originally delivered by the laser light generator 44, the described optical arrangement results in frequency quadrupling. A linear lens array 56 and a further imaging lens system 48″ in the three optically parallel beam paths 54 that are otherwise superimposed in terms of optics assemblies ensure conditioning and focusing of the part-beams to the exposure site in a chamber above the sample carrier, where the three part-beams are combined again, especially in such a way that the foci of the part-beams lie one on top of another, in order to increase the fluence of the coherent electromagnetic waves where they are supposed to be effective.

The equal division of beam fluence between a multitude of optically parallel beam paths with identical optics assemblies in the example shown reduces the energy loss per frequency multiplier unit on passage of the pulsed beam, which would otherwise have a stronger effect on the optical properties and evolution of heat in the frequency multiplier units, and hence enables more stable and more reliable operating conditions, including over longer periods of time as can occur in the scanning of a tissue section.

In the example shown in FIG. 2, double frequency doubling takes place, which is suitable for the input energy bursts into the ablated sample material, as illustrated, for example, as laser pulses 32 in FIG. 1C. It is likewise possible to use a device shown in FIG. 2 with slight modifications for ablation energy bursts that bring about ablation of sample material, as illustrated, for example, as a pulsed beam 24 in FIG. 1A. In the case of irradiation of sample material prepared with a MALDI matrix substance, the used wavelength of the beam may preferably be 355 nanometres, which, given an output wavelength of the laser light generator of 1064 nanometres, corresponds to frequency tripling. For this application, in particular, the second nonlinear crystals 50′ in the different optically parallel beam paths should be adjusted appropriately, for instance such that they receive the originally infrared radiation and the already frequency-doubled radiation and emit radiation in the near ultraviolet. In such an ablation beam execution, the foci of the part-beams are directed onto the sample material on the sample carrier.

FIG. 3 is a schematic illustration of a beam profile from the site of generation of the beam (on the left in the figure) up to the site where a single beam is recreated from a multitude of part-beams (on the right in the figure) before the beam thus recreated is directed to a site of its use, according to principles of the present disclosure.

FIG. 3 shows a setup with three addressable optically parallel beam paths S-1, S-2, S-3, to which beam pulses of coherent electromagnetic waves may each be directed alternately. As above, the multitude of three beam paths S-1, S-2, S-3 should be considered to be illustrative, and other multitudes of optically parallel beam paths S-1 to S-n, e.g., n =two, four and the like, may likewise be set up as seems useful to the person skilled in the art for the application.

A laser light generator 44* emits pulses of coherent electromagnetic waves 46* in the infrared spectral region that are linear-polarized and conditioned by an imaging lens system 48* for entry into a first generator of a second harmonic 50*, which may take the form of a nonlinear crystal. A pulse sequence is indicated in the lower part of the figure, in time sequence, by dashed-and-dotted, dashed and dotted lines. Given an output wavelength of 1064 nanometres, frequency doubling leads to a pulse wavelength of 532 nanometres. The linear polarization state of the laser light may be in the plane of the drawing (arrow representation) or oscillate at right angles to the plane of the drawing (dot representation). In the example shown, the polarization oscillates in the plane of the drawing after exit from the generator of a second harmonic 50 *.

After passing through a further imaging lens system 48**, the pulses 46* enter a first electrooptical crystal EO #1. A voltage applied at the time of passage of the laser pulse 46* through the first crystal EO #1 decides the further path of the pulse 46*. If no voltage is applied, the dashed-and-dotted laser pulse 46* goes through a first polarizer Pol-1 to a first parallel generator of a second harmonic 50** in which the frequency is doubled once more and the wavelength is halved once more, for example from 532 nanometres on exit from the frequency multiplier unit 50* to 266 nanometres. After passing through a λ/2 plate, which is used in order to restore the polarization of the pulsed beam 46* that has been altered by the crystal in the frequency multiplication, and a fourth polarizer Pol-4, the dashed-and-dotted pulse 46* enters a recombined beam path S-All. This corresponds to the first beam path S-1.

The recombined beam path S-All, which continues in a chamber (not shown) in the direction of a sample carrier having sample material or is coupled into a chamber and guided in the direction of a sample carrier having sample material, may be assigned either to the ablation device 22 or to the energy input device 30 from FIGS. 1A to 1C, where the recombined beam S-All is incident on the sample material on the sample carrier for ablation (ablation energy burst) or passes through an ablation cloud of the sample material above the sample carrier (input energy burst).

If a λ/2 voltage is applied to the first electrooptical crystal EO #1, when a pulse 46* passes through, the laser pulse 46* is rotated by 90° in its polarization (arrow to dot representation) and deflected by the polarizer Pol-1 in the direction of a second electrooptical crystal EO #2.

If no voltage is applied to the second electrooptical crystal EO #2, the dashed laser pulse 46* goes through a second polarizer Pol-2 to a frequency multiplier unit in the form of a second parallel generator of a second harmonic 50**, which corresponds to the first parallel generator of a second harmonic on the beam path S-1, and here too passes through—exactly as in the beam path S-1—a λ/2 plate, is deflected by a third polarizer Pol-3, goes into a third electrooptical crystal EO #3 and is deflected by means of the fourth polarizer Pol-4 into the recombined beam path S-All if no voltage is applied to the third electrooptical crystal EO #3. This corresponds to the second beam path S-2.

If a λ/2 voltage is applied to any of the first, second and third electrooptical crystals EO #1, EO #2, EO #3 as a pulsed beam 46* passes through, the dotted pulse 46* passes through two beam-deflecting elements, e.g., mirrors 58, and a third frequency multiplier unit in the form of a third parallel generator of a second harmonic 50**, which corresponds to the generators of a second harmonic on the beam paths S-1 and S-2, to give the recombined beam path S-All. This corresponds to the third beam path S-3.

It is thus possible to address a respectively different beam path S-1, S-2, S-3 from pulse to pulse 46*, where all beam paths S-1, S-2, S-3 are identical with regard to the frequency multiplication properties:

| Multiplier passed | | | |
|---|---|---|---|
| through in | Voltage | Voltage | Voltage |
| beam path S-X | EO #1 | EO #2 | EO #3 |
| X = 1 | off | off/on | off/on |
| X = 2 | on | off | off |
| X = 3 | on | on | on |

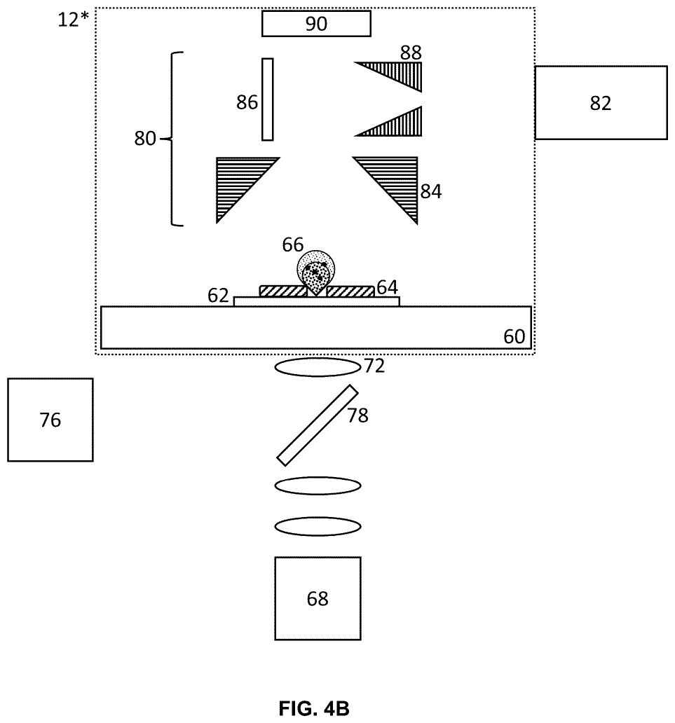

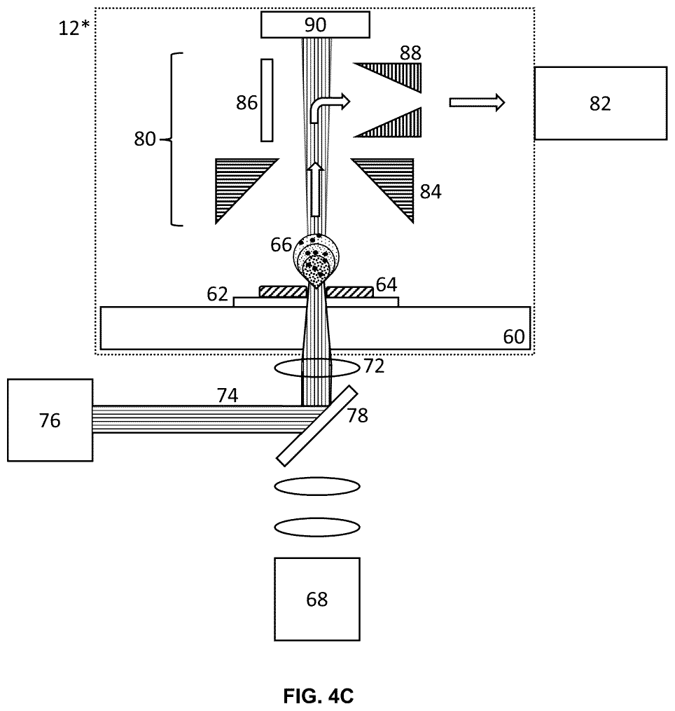

The branching of the originally uniform beam path makes it possible to distribute the energy input obtained in the frequency multiplication between a multitude of frequency multiplier units 50**, such that troublesome property drift and evolution of heat in the frequency multiplier units 50** are avoided or at least reduced. The switching of voltages in the electrooptical crystals EO #1, EO #2, EO #3 can be undertaken in intervals of nanoseconds, such that even rapid pulse sequences 46* in the region of several kilohertz can be distributed over the multitude of parallel optical beam paths S-1, S-2, S-3. This embodiment may therefore especially be suitable for ablation energy bursts from an ablation device, as illustrated as laser pulses 24 in FIG. 1A. It is likewise possible, however, to use this arrangement for input energy bursts from an energy input device, especially when the input energy bursts are passed through a sample carrier in transmitted light or in transmission, as illustrated in FIGS. 4A-4C.

The beam paths S-1, S-2, S-3 shown in FIG. 3, by virtue of the slightly different distances, cause slightly different traverse times of the pulses 46* from the laser light generator 44* up to the recombination point at the polarizer Pol-4, but these differences in traverse time can be kept in the region of one nanosecond, such that they do not affect a system that works with pulse cycle rates in the kilohertz range and pulse durations in the region of a few nanoseconds. It is possible to arrange traverse time-delaying optics assemblies in the shorter beam paths S-1, S-2 illustrated by way of example, in order to balance out differences in traverse time, if desired.

The alternate addressing of a multitude of optically parallel beam paths having identical optics assemblies in the example shown permits distribution of the energy input per pulsed beam over time between different parallel frequency multiplier units, so as to create phases in which the changes in the optical properties and evolution of heat in the frequency multiplier units that are caused by energy loss on passage of the pulsed beam can decay, and hence permits more stable and more reliable operating conditions, even over prolonged periods of operation as can occur, for example, in the scanning of a tissue section.

The optical setups that are apparent in the embodiments from FIGS. 2 and 3 are designed for exposure of the optically parallel frequency multiplier units 50′, 50** to monochromatic light, namely the light that exits from the respectively upstream frequency multiplier unit 50, 50*, which, in the examples shown, results in frequency quadrupling, for example from output wavelength 1064 nanometres to target wavelength 266 nanometres. However, it is also possible, by means of corresponding adaptations of the optical setups, to design the beam distribution and the beam paths such that the optically parallel frequency multiplier units 50′, 50** can be exposed to polychromatic light, for example simultaneously to green and infrared light, where the latter may originate directly from the laser light generator 44, 44*. It is within the knowledge and ability of the person skilled in the art to integrate optical beam deflectors and beam modifiers for light having more than one wavelength or frequency into the optical setups shown, in order to enable polychromatic exposure of the optically parallel frequency multiplier units 50′, 50**. In this way, it is also possible to achieve frequency tripling, for example from output wavelength 1064 nanometres to target wavelength 355 nanometres, or frequency quintupling, for example from output wavelength of 1064 nanometres to target wavelength 213 nanometres.

FIG. 4A illustrates a schematic setup in which principles of the present disclosure can be implemented. What is shown is a control element 60 in an optionally gas-tight chamber 12*, bearing a sample carrier 62 and sample material 64. The control element 60 may be executed, for example, in the form of an x-y translation stage that can be moved in two spatial directions in the chamber 12* in order to bring several ablation sites on the sample carrier 62 successively into an ablation position. Alternative control elements also enable movement in z direction (at right angles to the sample carrier surface) in order, for example, to be able to adjust light-optical foci and/or compensate for morphological differences between sample material 64 and sample carrier material (e.g., glass). The sample carrier 62 preferably has standard dimensions, for example the dimensions of a microtitration plate, as frequently used for mass spectrometry and/or mobility spectrometry measurements on ablated charged molecules, and is at least partly transparent to electromagnetic waves. This may be a glass microscope slide as customary in microscopy. The sample material 64 may, as shown, be coherent material having a two-dimensional extent, for example a tissue section, which is scanned in grid fashion by a mass spectrometry measurement, in order to create a two-dimensional view (“map”) of its molecular content, for example with regard to biomolecules (such as proteins, peptides, lipids, glycans, etc.), pharmaceuticals, metabolism products and the like.

In the view of FIG. 4A, an ablation device that is disposed beneath the control element 60 outside the chamber 12*, in this execution, comprises a laser system 68 for creation of a pulsed laser beam 70 which is guided via various light-optical elements such as lenses and mirrors to the control element 60 such that it passes through a chamber wall, the control element 60 and the sample carrier 62 at a point corresponding to the ablation site on the front face of the sample carrier 62. The pulsed beam 70 can then interact with sample material 64 at the ablation site on the front side of the sample carrier 62, and the energy input leads to ablation of the corresponding sample material section in a constantly extending cloud 66 at the ablation site above the sample carrier 62. The guiding of a pulsed ablation beam in transmitted light or in transmission through the sample carrier 62 allows positioning of the last imaging lens 72 at a very small distance from the sample carrier 62, which enables bundling of the pulsed beam 70 to a very small focal point at the ablation site on the surface of the sample carrier 62 in a technically very easy manner; a prerequisite for scanning of two-dimensional sample material 64, for example a tissue section, with sub-cellular grid size (<1 micrometer) for single cell analyses.

Likewise beneath the control element 60, outside the chamber 12*, is disposed an energy input device which includes a laser system 76 in this execution. The energy input device shown shares some of its light-optical elements with the ablation device, in the example shown a semi-transparent mirror 78 that serves for deflection of the pulsed beam of coherent electromagnetic waves 74 emitted by the laser system 76, whereas it is transparent to the pulsed laser beam 70 from the ablation device, and also the imaging lens 72, where the lens 72 may also be representative of a lens system. The lens 72 or the corresponding lens system have preferably been chromatically corrected. The pulsed beam of electromagnetic waves 74 of the laser system 76 is sent, in a manner timed with the ablation, in transmission through the chamber wall, the control element 60 and the sample carrier 62, into the ablation cloud 66 above the sample carrier 62 in order to interact there directly or indirectly via chemical secondary reactions with the ablated sample material in the gas phase and to induce further ionization.

The chamber wall, the control element 60 and the sample carrier 62, and the last imaging lens 72, are preferably designed such that they have essentially the same transmission properties and if appropriate imaging properties for coherent electromagnetic waves of different wavelength, for example 355 nanometres for the pulsed laser beam 70 from the ablation device and 266 nanometres for the pulsed beam of coherent electromagnetic waves 74 from the energy input device. Suitable material for these transparent elements is, for example, quartz glass, calcium fluoride, preferably in a chromatically compensated embodiment as a lens system.

In the view in FIG. 4A, an extraction device 80 is shown above the control element 60. The extraction device 80 comprises several electrodes that may be connected permanently or temporarily to electrical potentials, such that ions are extracted from the ablation cloud 66 and guided to a mobility analyser system, mass analyser system or combined mobility-mass analyser system (schematically indicated in 82 outside the chamber 12*). In a first section, the extraction device 80 may comprise an electrode stack 84 in the form of a radio-frequency voltage funnel, i.e., perforated plates arranged in series and having middle openings, the size of which varies, and especially becomes smaller, across the stack, which serves for greater spatial focusing of the extracted ions. Consequently, the perforated plate having the largest opening faces the ablation site. Behind the RF funnel 84, to the side of the ion path, is a deflecting electrode 86 that can permanently or temporarily receive an electrical potential that repels ions having particular polarity, in order to deflect their path into a second RF funnel 88 which is disposed opposite the deflecting electrode 86, and the inner openings of which decrease away from the deflecting electrode 86. The analyser 82, which may be present in an environment having a different pressure level, for example at a lower pressure, then accepts and processes the spatially more strongly focused ions. Neutral particles and molecules in the ablation cloud 66, by contrast, are unaffected by the deflecting electrode 86, and are able to freely dissipate and are diluted.

FIG. 4A illustrates, for a first step, an ablation energy burst for ablation of sample material 64 in that the laser system 68 of the ablation device emits a short high-energy laser pulse 70 that penetrates into the sample material 64 on the reverse side at a point corresponding to the ablation site, after having passed through the light-optical guide elements, the chamber wall, the control element 60 and the sample carrier 62. The sample material 64 may be a two-dimensional tissue section that has been laid out on a glass slide and treated over the full area with a matrix substance in the crystallized state. The laser light may, for example, have a wavelength of about 355 nanometres, as can be generated by frequency tripling of the light from an Nd:YAG laser in the infrared spectral region at 1064 nanometres. The prepared sample material 64 and the ablation energy burst or a sequence of rapidly successive ablation energy bursts that are of the same kind or essentially similar are matched to one another such that the sample material 64 together with matrix substance is removed virtually completely at the ablation site. This can be established in a very reliable manner via the pulse count, pulse length and fluence of the laser beam 70. Two-dimensional sample material 64, for example a matrix-prepared tissue section with thickness about 10 micrometres, can be locally fully ablated in an efficient manner.

FIG. 4B shows, for a second step, how the ablated sample material in the gas phase extends away from the ablation site and is diluted. In the present example, preparation with a MALDI matrix substance on the sample carrier 62 ensures that the ablated matrix substance provides charge carriers in the form of protons, which are transferred in the ablation cloud 66 to the simultaneously ablated sample molecules and hence perform a first ionization step. Regrettably, the comparatively low ionization efficiency of the simple MALDI process can have the effect that a considerable portion of the neutral sample molecules ablated is not ionized by the charge carriers generated on supply of the ablation energy burst or the multiple ablation energy bursts. The ionization yield may vary from molecule type to molecule type. Particular lipids, for example, are known to have relatively poor ionization compared to proteins and peptides under standard MALDI conditions.

In order to further improve the ionization yield per ablation energy burst or sequence of ablation energy bursts—as illustrated in FIG. 4C for a third step—pulsed beams of high-energy coherent electromagnetic waves 74 are passed by the laser system 76 into the ablated sample material above the ablation site, where—just like the pulsed ablation radiation 70 from the ablation device—they pass from the reverse side to the front side through the chamber wall, the control element 60 and the sample carrier 62. In this way, they arrive in the ablation cloud 66, where they interact with the ablated molecules and in particular excite matrix molecules, such that a higher number of charge carriers in the form of protons is provided for transfer to ablated neutral sample molecules. It is especially the ionization of molecules that are highly dilute or difficult to ionize in the sample material 64, for example particular lipids, that profits therefrom. The pulsed beam of coherent electromagnetic waves 74 may take the form of pulses that are generated and emitted in quick succession, for example by a pulse laser, or they may come from discontinuous operation of the energy input device, for example time-limited operation of a continuous wave laser, where the time limit may especially be set in the region of a few milliseconds.

The state from FIG. 4B between the ablation step from FIG. 4A and the energy input step from FIG. 4C should be considered to be a schematic illustration. The duration of the state between ablation and energy input which is shown in FIG. 4B may be very short, for example be a few microseconds or only a few hundred nanoseconds. Also conceivable are embodiments in which there is virtually no occurrence of a separate state with expansion of an ablation cloud 66, as shown in FIG. 4B, namely when an ablation energy burst or a sequence of ablation energy bursts and a pulse of coherent electromagnetic waves for energy input follow one another virtually without time delay, with appropriate matching of the ablation device and the energy input device. This low to virtually zero time delay can have the advantage that the cloud 66 of ablated sample material is still quite dense when the pulsed beam of coherent electromagnetic waves 74 penetrates into it, which increases the probability of interaction between photons and ablated particles and molecules.

The ions formed may be extracted from the ablation cloud 66 by means of permanent or temporary electrical extraction potentials on the electrodes of the extraction device 80, and directed to the analyser 82 (see arrows in FIG. 4C). The fraction of the coherent electromagnetic waves that has passed through the ablation cloud 66 without interacting with the molecules present therein can be absorbed by a beam trap 90 which is disposed in the optical pathway downstream of the extraction device 80 and removes the high-energy radiation from the apparatus without it reaching sites or possibly having an effect in an unintended or unwanted manner.

The energy input device from FIGS. 4A to 4C can work with high-energy pulsed laser radiation, for example having a wavelength of 266 nanometres, which can be generated by frequency quadrupling of an Nd:YAG laser with an infrared output wavelength. The coherent electromagnetic waves used for energy input, as well as the influence on already ablated sample material, may also remove residues of the sample material 64 from the exposure site, if the ablation pulse or the sequence of ablation pulses, contrary to expectation, should not have fully exposed the sample carrier surface at the exposure site. The coherent electromagnetic waves from the energy input device may additionally interact with pieces of the sample material (debris) that have formed in the removal operation and have been entrained in the ablation cloud 66, in order to convert sample material from these pieces to the gas phase and to ionize it. This additionally subsequently ablated (residual) sample material can also further increase the yield of ions to be generated.

Once the ions formed in the ablation and subsequent energy input have been extracted from the ablation cloud 66 and passed onward to the analyser 82, the control element 60 can move the sample carrier 62 to a further ablation setting (x-y translation), optionally including an adjustment of the focus (z translation), such that it is possible to examine an as yet untouched part of the sample material 64. If the sample material 64 is a tissue section, the surface thereof can be scanned in a particular sequence in this manner, in order to create a map of the molecular content, for example with regard to lipids, proteins, peptides, glycans or similar biomolecules, but also with regard to pharmaceuticals and the degradation products thereof, (endogenous) metabolism products, etc.

It will be apparent that implementations of beam guiding as illustrated in FIG. 3 and having a division and a recombination, in the setup shown in FIGS. 4A-4C, are suitable both for the ablation laser system 68 and, alternatively or additionally, for the energy input laser system 76.

The invention is described above with regard to various particular working examples. However, it will be apparent that various aspects or details of the executions described can be altered without deviating from the scope of the invention. In addition, the features and measures disclosed in association with different embodiments may be combined as desired, if this seems practicable to a person skilled in the art. Moreover, the present description serves merely for illustration of the invention and not for restriction of the scope of protection, which is defined exclusively by the appended claims with regard to any existing equivalents.

1. An apparatus for generating ions from sample material deposited on a sample carrier, comprising:
a chamber in which the sample carrier and the sample material are maintained in a conditioned environment,
an ablation device that locally ablates the deposited sample material using an ablation energy burst in the chamber that converts it to a gas phase,
an energy input device that exposes the ablated sample material present above the sample carrier in the chamber after the ablation energy burst to an input energy burst, and
an extraction device that extracts ions from the ablated sample material exposed to the input energy burst and transfers them to an ion processing apparatus,
wherein the ablation energy burst and/or input energy burst comprises a beam of coherent electromagnetic waves and the ablation device and/or the energy input device comprises a beam distributor that provides a plurality of optically parallel beam paths that each have a frequency multiplier unit and are combined again for the ablation energy burst and/or input energy burst, all of the frequency multiplier units emitting a uniform output frequency.

2. The apparatus according to claim 1, wherein the chamber is substantially gas-tight and is connected to a vacuum source.

3. The apparatus according to claim 1, wherein the chamber is connected to a gas supply that establishes a predetermined gas composition.

4. The apparatus according to claim 1, wherein the ablation device comprises an ablation pulse laser or pulsed ablation laser having beam-guiding ablation optics assemblies that direct ablation energy bursts in the form of ablation laser light pulses locally onto the deposited sample material in the chamber.

5. The apparatus according to claim 1, wherein the beam distributor comprises a diffractive optical element or a refractive optical element.

6. The apparatus according to claim 1, wherein the energy input device has a laser light generator for generation of input energy bursts, upstream of the beam distributor.

7. The apparatus according to claim 6, wherein the laser light generator comprises an energy input pulse laser or pulsed energy input laser, and wherein the energy input device includes beam-guiding input optics assemblies that direct input energy bursts in the form of energy input laser light pulses that spread substantially parallel or substantially at right angles to a surface normal of the sample carrier into the ablated sample material present above the sample carrier in the chamber.

8. The apparatus according to claim 7, wherein the beam-guiding input optics assemblies include one or more imaging optics assemblies disposed between a frequency multiplier unit and: (i) an exposure site above the sample carrier in the chamber; and/or (ii) the laser light generator.

9. The apparatus according to claim 7, wherein the energy input device triggers an energy input laser light pulse after, and timed with, an ablation energy burst.

10. The apparatus according to claim 6, wherein the laser light generator generates laser light in the infrared spectral region.

11. The apparatus according to claim 1, wherein the energy input device has a first generator of a second harmonic, upstream of the beam distributor.

12. The apparatus according to claim 11, wherein each frequency multiplier unit comprises a second generator of a second harmonic, and the first generator of a second harmonic and the second generators of a second harmonic together constitute generators of a fourth harmonic.

13. The apparatus according to claim 1, wherein each frequency multiplier unit and/or generator of a second harmonic has a multiplier crystal.

14. The apparatus according to claim 1, wherein each frequency multiplier unit multiplies a uniform input frequency to a uniform output frequency.

15. The apparatus according to claim 1, wherein the energy input device spatially arranges the plurality of optically parallel beam paths one on top of another in the ablated sample material present above the sample carrier in the chamber.

16. The apparatus according to claim 1, wherein the beam distributor comprises one or more switchable beam switches that guide an incoming beam of coherent electromagnetic waves substantially completely onto a selected beam path of the plurality of optically parallel beam paths.

17. The apparatus according to claim 1, wherein the energy input device arranges the multitude of optically parallel beam paths one on top of another upstream of an exposure site above the sample carrier in the chamber and focuses the correspondingly recombined beam of coherent electromagnetic waves into the exposure site.

18. The apparatus according to claim 1, wherein the extraction device has one or more electrodes connected to a voltage source that applies a sustained electrical extraction potential or, several times in succession, an electrical extraction potential pulse.

19. The apparatus according to claim 1, wherein the extraction device includes an interface in the chamber to an ion processing chamber in which the ion processing apparatus is disposed.

20. The apparatus according to claim 1, wherein the ion processing apparatus is part of an ion analyser.

21. A method of generating ions from sample material deposited on a sample carrier using an apparatus according to claim 1, the method comprising:
locally ablating the deposited sample material using an ablation energy burst that converts it to the gas phase,
exposing the ablated sample material present above the sample carrier after the ablation energy burst to an input energy burst, and
extracting ions from the ablated sample material that has been exposed to the input energy burst and transferring them to an ion processing apparatus.
